(19) United States
(12) Patent Application Publication
(10) Pub. No.: US 2019/0168795 A1
(43) Pub. Date: Jun. 6, 2019

(54) VEHICLE OPERATION SYSTEM AND COMPUTER READABLE NON-TRANSITORY STORAGE MEDIUM

(71) Applicant: DENSO CORPORATION, Kariya-city, Aichi-pref. (JP)

(72) Inventors: Kensuke SUZUKI, Kariya-city (JP); Yoshinori WATANABE, Kariya-city (JP); Taiichiro ICHIMARU, Kariya-city (JP); Daisuke NAMEKAWA, Kariya-city (JP); Kazutomo TSUCHIKAWA, Kariya-city (JP); Daisuke SUZUKI, Kariya-city (JP)

(21) Appl. No.: 16/325,197

(22) PCT Filed: Jun. 29, 2017
(86) PCT No.: PCT/JP2017/023967

§ 371 Date: Feb. 13, 2019

(30) Foreign Application Priority Data
Sep. 2, 2016 (JP) 2016-171777

(51) Int. Cl. B62D 1/04; B62D 1/06; B60R 16/027; G06F 3/03

(52) U.S. Cl. CPC B62D 1/046; G06F 3/03; B60R 16/027; B62D 1/06

(57) ABSTRACT

A vehicle operating system that controls a control target device by performing a slide operation in which a driver slides a hand along a steering wheel, includes: an operation determination unit for determining whether the driver performs the slide operation; a steering angle determination unit for determining a steering angle when the driver performs the slide operation; and a device controller for determining whether to control the control target device, according to a determination result of the operation determination unit and a determination result of the steering angle determination unit.

### CROSS REFERENCE TO RELATED APPLICATION

The present application is based on Japanese Patent Application No. 2016-171777 filed on Sep. 2, 2016, the disclosure of which is incorporated herein by reference.

### TECHNICAL FIELD

The present disclosure relates to a vehicle operation system and a computer program.

### BACKGROUND ART

A vehicle operation system that controls a control target device by performing a predetermined operation of a driver to a steering wheel of the vehicle is suggested. In this type of vehicle operating system, display information (that is, an icon or the like) indicating the content of the operation on the steering wheel is displayed on, for example, a head up display or the like so that the driver can visually recognize it. By visually recognizing the display information and performing a predetermined operation on the steering wheel, the driver can perform, for example, various settings of the audio device, for example, at the periphery of the steering wheel with less visual line movement from the front of the vehicle.

### PRIOR ART LITERATURES

### Patent Literature

Patent Literature 1: JP-5909048-B2

### SUMMARY OF INVENTION

There is a sliding operation for sliding the hand along the steering wheel as one of the predetermined operations performed by the driver with respect to the steering wheel, and it is conceivable that the driver performs the sliding operation, for example, to adjust the setting sound volume of the audio device. On the other hand, for example, even when the driver turns right or left at an intersection during driving or travels on a curve, there is a case where a sliding operation (that is, a push steering operation or a pull steering operation) is performed to slide one hand along the steering wheel. Therefore, when the driver performs a slide operation during driving at the intersection, such as turning right or left, or running on a curve, there is concern that, for example, the setting sound volume of the audio device may be adjusted accidentally against the driver's intention.

The present disclosure provides a vehicle operation system and a computer program that can appropriately control a control target device when a driver performs a slide operation to slide a hand along a steering wheel.

According to one aspect of the present disclosure, in a vehicle operation system that performs a control of a control target device by performing a slide operation in which a driver slides a hand along a steering wheel, the operation determination unit determines whether the driver performs the slide operation. The steering angle determination unit determines the steering angle when the driver performs the slide operation. Using the determination result of the operation determination unit and the determination result of the steering angle determination unit, the device controller determines whether the control of the control target device is to be executed.

Using the determination result whether the driver performs the slide operation and the determination result of the steering angle when the driver performs the slide operation, it is determined whether the control of the control target device is to be executed. When the steering angle at the time when the driver performs the slide operation is less than the predetermined angle, it is determined that the slide operation is not the steering operation of the own vehicle but the slide operation having the purpose of the control for the control target device, and the control of the control target device is performed. On the other hand, when the steering angle when the driver performs the slide operation is equal to or larger than the predetermined angle, it is determined that the slide operation is a slide operation aimed at steering the own vehicle, not the control of the control target device, and the control of the control target device is not performed. It is determined whether the slide operation performed by the driver is the slide operation aimed at controlling the control target device or the slide operation aimed at steering the own vehicle, so that it is determined whether the control of the control target device is executed. Thus, it is possible for the driver to control the control target device in accordance with the intention of the driver when the driver performs the slide operation, and it is possible to avoid the situation where the control target device is controlled accidentally against the driver's intention.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram showing one embodiment;

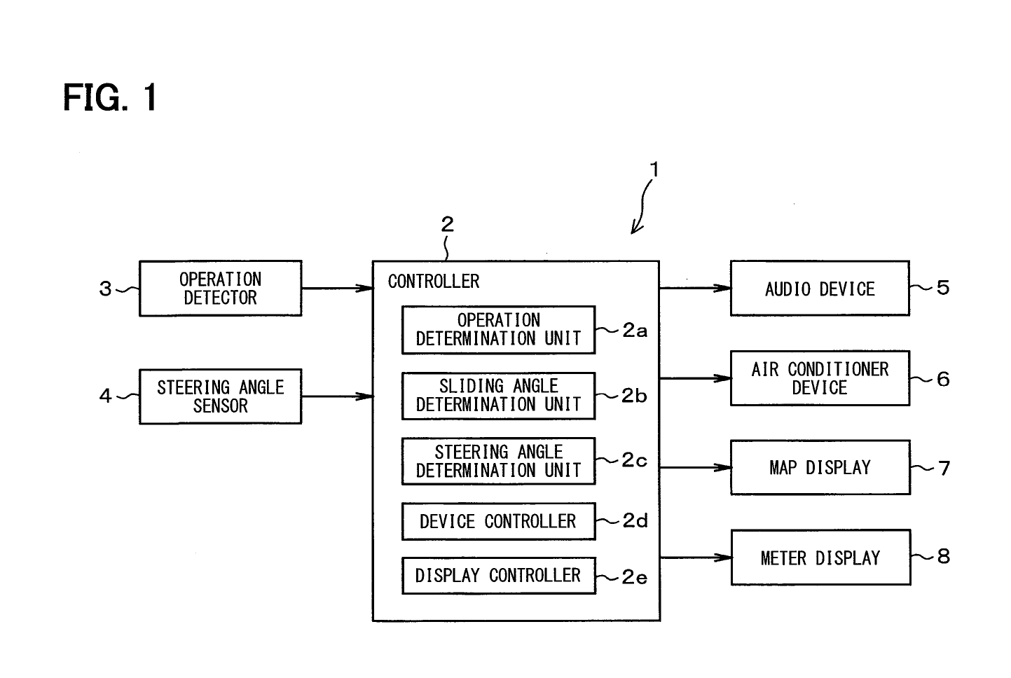

FIG. 2 is a diagram showing a configuration of the periphery of a steering wheel and a meter display;

FIG. 3 is a diagram (part 1) showing a display mode of display information;

FIG. 4 is a diagram (part 1) showing an operation mode of a slide operation and a display mode of display information;

FIG. 5 is a diagram (part 2) showing an operation mode of a slide operation and a display mode of display information;

FIG. 6 is a flowchart;

FIG. 7 is a diagram (part 3) showing an operation mode of a slide operation and a display mode of display information;

FIG. 8 is a diagram (part 4) showing an operation mode of a slide operation and a display mode of display information; and

FIG. 9 is a diagram (part 5) showing an operation mode of a slide operation and a display mode of display information.

### EMBODIMENTS FOR CARRYING OUT INVENTION

Hereinafter, an embodiment will be described with reference to the drawings. The vehicle operation system 1 includes a controller 2, an operation detector 3, a steering angle sensor 4, an audio device 5 (corresponding to a control target device), an air conditioner device 6 (corresponding to a control target device), a map display 7 (corresponding to a control target device), and a meter display 8.

The operation detector 3 includes an electrostatic sensor arranged in a steering wheel 9 having a ring shape in the vehicle compartment, detects the operation of the driver with respect to the steering wheel 9, and transmits an operation detection signal indicating the detected operation of the driver to the controller 2. The operation detector 3 may be configured to include any sensor as long as the detector 3 detects the operation of the driver with respect to the steering wheel 9, and may include a configuration with a light sensor, a temperature sensor, a pressure sensor, and the like. The operation of the driver detected by the operation detector 3 is an operation of the driver hitting the steering wheel 9 with a finger, a sliding operation of the driver sliding a hand along the steering wheel 9, and the like.

The steering angle sensor 4 detects the steering angle when the driver steers the steering wheel 9, and outputs a steering detection signal indicating the detected steering angle to the controller 2. The audio device 5, the air conditioner device 6, and the map display 7, perform the control specified by the input control signal when each device receives the control signal from the controller 2. Upon inputting, for example, a control signal designating the adjustment of the setting sound volume or the like from the controller 2, the audio device 5 adjusts the setting sound volume or the like. When the controller 2 inputs, for example, a control signal designating the adjustment of the set temperature, the set air volume, or the like into the air conditioner device 6, the air conditioner device 6 adjusts the set temperature, the set air volume or the like. The map display 7 performs enlargement or reduction of the map screen and the like when a control signal designating, for example, the enlargement or the reduction of the map screen, and the like is input from the controller 2.

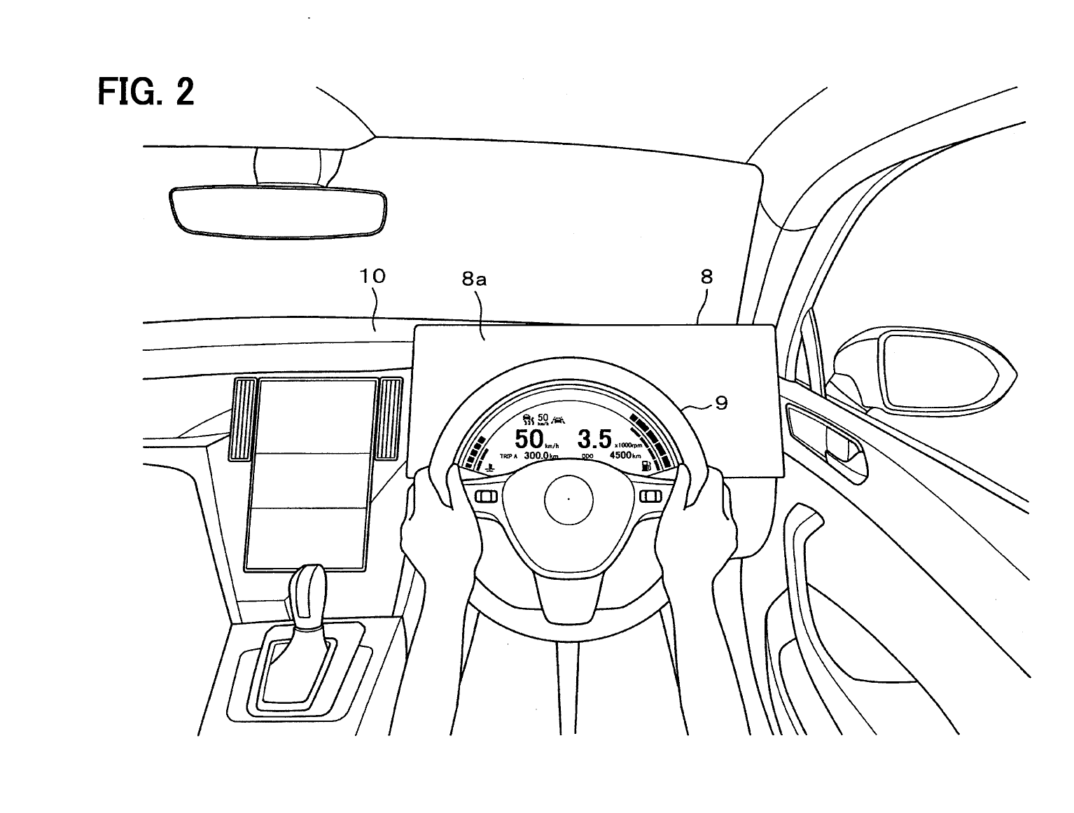

As shown in FIG. 2, the meter display 8 is arranged between the steering wheel 9 and the dashboard 10 in the passenger compartment, and is disposed on the far side of the steering wheel 9 when seeing from the visual line of the driver. In the meter display 8, most of the planar portion on the side of the steering wheel 9, that is, the planar portion on which the driver can visually recognize is set as the display area 8a. When a display command signal is input from the controller 2, the information designated by the display command signal is displayed in the display area 8a. The information displayed in the display area 8a of the meter display 8 is the vehicle speed, the engine rotation speed, the cumulative travel distance, the fuel amount, the image of the electronic mirror system, and the like.

The controller 2 is constituted by a microcomputer having a CPU (i.e., Central Processing Unit), a ROM (i.e., Read Only Memory), a RAM (i.e., Random Access Memory), and an I/O device (i.e., Input/Output device). The controller 2 executes a computer program stored in a non-transitory tangible storage medium to execute a process corresponding to the computer program, and controls the overall operation of the vehicle operation system 1.

The controller 2 includes an operation determination unit 2a, a slide angle determination unit 2b, a steering angle determination unit 2c, a device controller 2d, and a display controller 2e. Each of these devices 2a to 2e is constituted by a computer program executed by the controller 2, and is realized by software.

Upon receiving the operation detection signal from the operation detector 3, the operation determination unit 2a determines the operation of the driver with respect to the steering wheel 9 according to the input operation detection signal. That is, when the operation determination unit 2a determines that the slide operation has been performed, for example, under a condition that the setting sound volume of the audio device 5 is adjustable by the slide operation, the operation determination unit 2a is able to determine that the slide operation is the slide operation aiming at adjusting the setting volume of the audio device 5. When the operation determining unit 2a determines that the sliding operation has been performed, for example, under a condition that the set temperature of the air conditioner device 6 or the set air volume is adjustable by a sliding operation, the operation determination unit 2a is able to determine that the sliding operation is the slide operation aiming at the adjustment of the set temperature of the air conditioner device 6 and the set air volume. When the operation determination unit 2a determines that the slide operation has been performed, for example, under a condition that the map screen of the map display 7 is zoomable by the slide operation, the operation determination unit 2a is able to determine that the slide operation is the slide operation aiming at zooming in and out the map screen of the map display 7.

Upon receiving the operation detection signal from the operation detector 3, the slide angle determination unit 2b determines the start point and the end point of the slide operation according to the input operation detection signal, and determines the slide angle indicating the operation amount of the slide operation. When the distance from the start point to the end point of the slide operation is relatively long, the slide angle determination section 2b determines the slide angle to be relatively large. On the other hand, when the distance from the start point to the end point of the slide operation is relatively short, the slide angle determination unit 2b determines the slide angle to be relatively small. Upon input the steering detection signal from the steering angle sensor 4, the steering angle determination unit 2c determines the steering angle according to the input steering detection signal.

Using the determination result of the operation determination unit 2a, the determination result of the slide angle determination unit 2b, and the determination result of the steering angle determination unit 2c, the device controller 2d determines whether the control signal is to be input into the audio device 5, the air conditioner device 6, or the map display 7, and determines whether the control of the audio device 5, the air conditioner device 6, or the map display 7 is to be executed. The display controller 2e outputs the display command signal to the meter display 8, and displays the display information in the display area 8a.

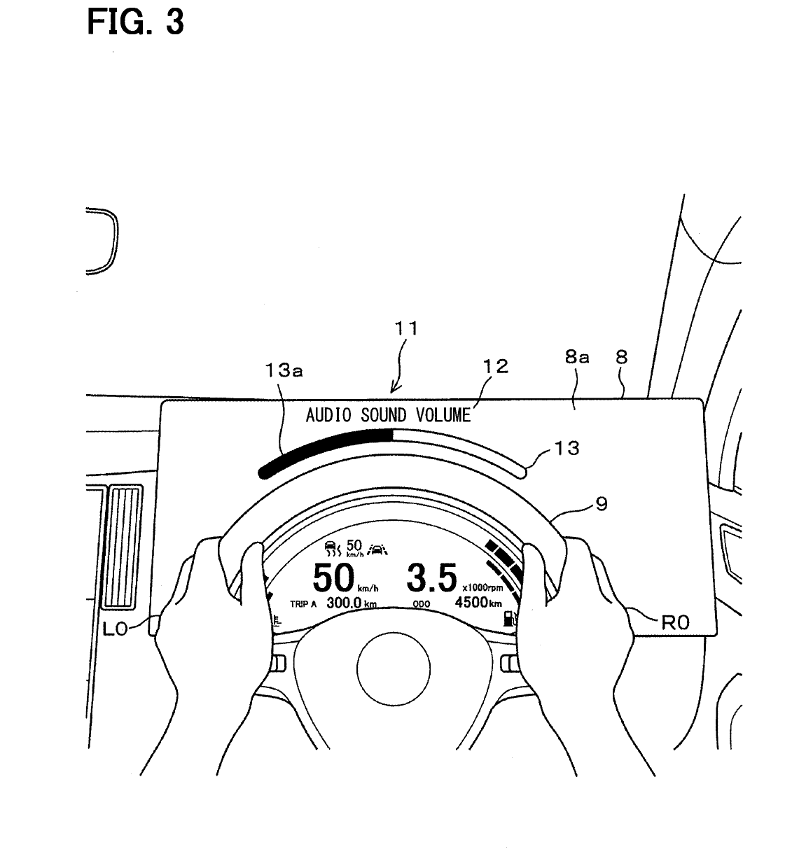

In the above configuration, for example, when the setting volume of the audio device 5 is adjustable by the slide operation, as shown in FIG. 3, the controller 2 displays the display information 11 indicating the magnitude of the set sound volume (that is, the character string 12 of “audio volume” and the arc-shaped slide bar 13) in a display manner along the shape of the steering wheel 9. When the set sound volume is relatively large, the controller 2 lengthens the length of the variable area 13a of the slide bar 13 in the arc direction to be relatively long, and displays it. On the other hand, when the set sound volume is relatively small, the controller 2 shortens the length of the variable area 13a of the slide bar 13 in the arc direction to be relatively short, and displays it. By visually recognizing the display information 11, the driver can grasp the current setting sound volume.

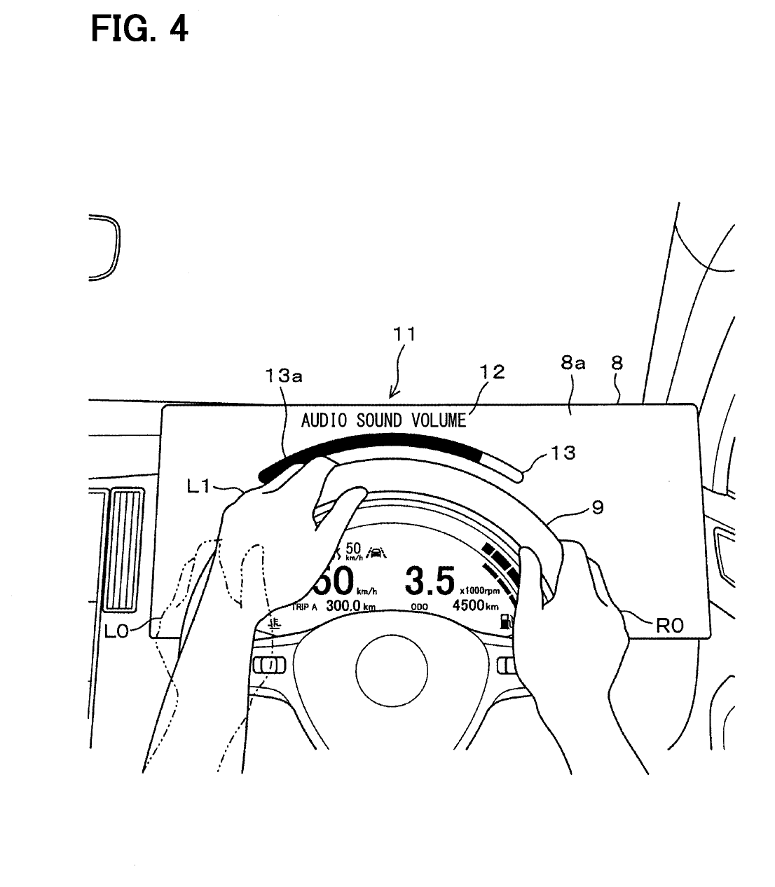

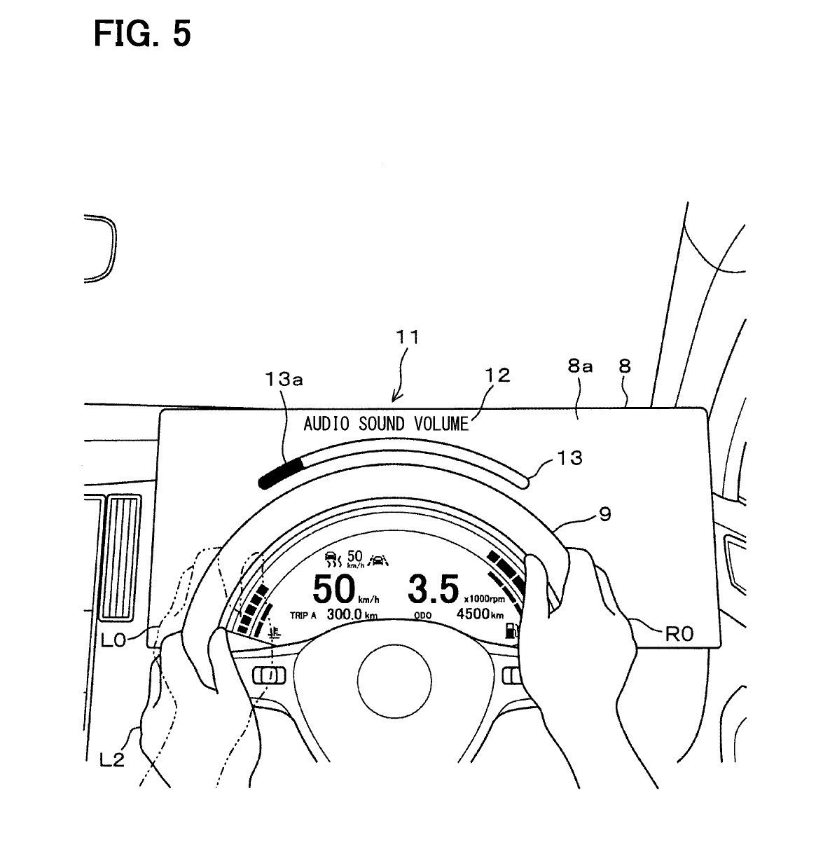

When determining that the driver has performed a sliding operation to slide the left hand along the steering wheel 9 after the state shown in FIG. 3, the controller 2 outputs a control signal to the audio device 5, adjusts the set sound volume of the audio device 5, outputs the display command signal to the meter display 8, and adjusts the length of the variable area 13a of the slide bar 13. That is, as shown in FIG. 4, when the controller 2 determines that the driver performs the slide operation in which the driver slides the left hand in the clockwise direction along the steering wheel 9 after the state shown in FIG. 3 (that is, the driver slides the left hand from the position of “L0” to the position of “L1”), the controller 2 changes the setting volume of the audio device 5 to be large, and changes the length of the variable area 13a of the slide bar 13 to be long. On the other hand, as shown in FIG. 5, when the controller 2 determines that the driver performs the slide operation in which the driver slides the left hand in the counter-clockwise direction along the steering wheel 9 after the state shown in FIG. 3 (that is, the driver slides the left hand from the position of “L0” to the position of “L2”), the controller 2 changes the setting volume of the audio device 5 to be small, and changes the length of the variable area 13a of the slide bar 13 to be short.

In this way, the driver can adjust the setting volume of the audio device 5 by the sliding operation using the left hand, for example, under a condition that the setting volume of the audio device 5 is adjustable by the sliding operation, and the driver can grasp the degree of the adjustment according to the slide bar 13. Similarly, the driver can adjust the set temperature of the air conditioner device 6 and the set air volume by the sliding operation using the left hand, for example, under a condition that the set temperature of the air conditioner device 6 and the set air volume are adjustable by performing the slide operation, and the driver can grasp the degree of adjustment according to the slide bar 13. Further, the driver can enlarge or reduce the map screen of the map display 7 by performing the slide operation using the left hand, for example, under a condition that the map screen of the map display 7 is zoomable by performing a slide operation, and the driver can grasp the degree of the enlargement/reduction according to the slide bar 13. It should be noted that the driver preliminarily selects the control target by the slide operation, that is, the adjustment of the set sound volume of the audio device 5, the adjustment of the set temperature of the air conditioner device 6 or the setting air volume, or the scaling of the map screen of the map display 7 in advance. Then, the driver performs the slide operation with the left hand.

In such a configuration in which the driver performs the slide operation, the control of the audio device 5, the air conditioner device 6, and the map display 7, there may be a concern that the control is performed accidentally against the driver's intention. Regarding this point, the controller 2 performs the following control.

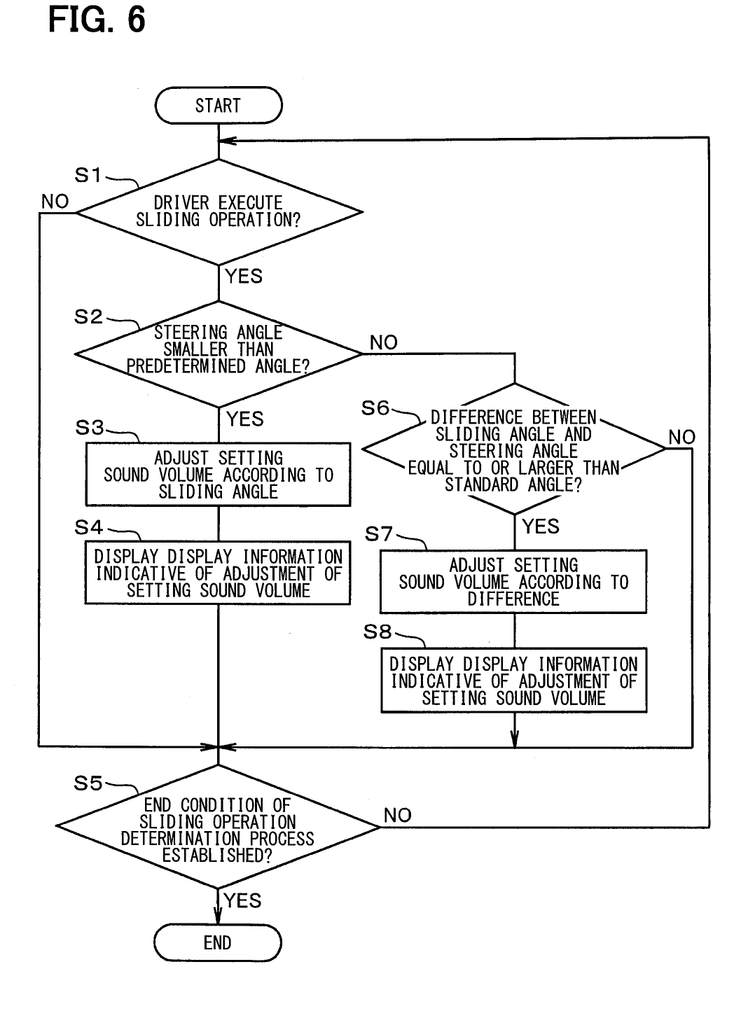

Next, the process of the above configuration will be described with reference to FIGS. 6 to 9. The controller 2 performs a slide operation determination process. Here, a case where the driver adjusts the set sound volume of the audio device 5 by performing a slide operation with the left hand will be described. When the start condition of the slide operation determination process such as the switching of the accessory switch from an off state to an on state is established, the controller 2 starts the slide operation determination process. Upon starting the slide operation determination process, the controller 2 determines whether the driver has performed a slide operation based on the operation detection signal input from the operation detector 3 (at S1, corresponding to the operation determination procedure).

When the controller 2 determines that the driver has not performed the slide operation (NO at S1), the controller 2 determines whether the end condition of the slide operation determination process is satisfied (at S5). On the other hand, when determining that the driver has performed the slide operation based on the operation detection signal input from the operation detector 3 (YES at S1), the controller 2 determines the steering angle based on the steering detection signal input from the steering angle sensor 4. Then, the controller 2, determines whether the steering angle is less than the predetermined angle (at S2, corresponding to the steering angle determination procedure). In this case, the controller 2 sets the predetermined angle to be, for example, 0 degree, or an angle close to extremely 0 degree corresponding to so-called allowance.

When determining that the steering angle is less than the predetermined angle (YES at S2), the controller 2 determines the slide angle of the slide operation, outputs a control signal corresponding to the determined slide angle to the audio device 5, and adjusts the setting sound volume of the audio device 5 (at S3, corresponding to the device control procedure). That is, when determining that the sliding operation is a sliding operation in the clockwise direction, the controller 2 adjusts the setting volume of the audio device 5 to be large according to the sliding angle. On the other hand, when determining that the sliding operation is a sliding operation in the counter-clockwise direction, the controller 2 adjusts the setting volume of the audio device 5 to be small in accordance with the sliding angle.

The controller 2 outputs a display command signal corresponding to the slide angle to the meter display 8, and displays the display information 11 indicating adjustment of the set volume of the audio device 5 in the display area 8a (at S4). That is, the controller 2 changes the length of the variable area 13a of the slide bar 13 according to the slide angle, and presents to the driver that the setting sound volume of the audio device 5 has been adjusted. Then, the controller 2 determines whether the end condition of the slide operation determination process is satisfied (at S5).

On the other hand, when determining that the steering angle is not less than the predetermined angle (that is, the steering angle is equal to or larger than the predetermined angle) (NO at S2), the controller 2 determines the slide angle of the slide operation, calculates the difference between the slide angle and the steering angle, and determines whether the calculated difference is equal to or greater than the reference angle (at S6). In this case, the controller 2 sets the reference angle to be larger than the above-mentioned predetermined angle.

When determining that the difference is less than the reference angle (NO at S6), the controller 2 does not output the control signal to the audio device 5, does not output the display command signal to the meter display 8, and determines whether the end condition of the slide operation determination process is satisfied (at S5).

On the other hand, when determining that the difference is equal to or greater than the reference angle (YES at S6), the controller 2 outputs a control signal corresponding to the difference to the audio device 5, and adjusts the set sound volume of the audio device 5 (at S7). The controller 2 outputs a display command signal corresponding to the difference to the meter display 8, and displays the display information 11 indicating the adjustment of the set sound volume of the audio device 5 in the display area 8a (at S8). Then, the controller 2 determines whether the end condition of the slide operation determination process is satisfied (at S5).

The controller 2 determines whether the end condition of a slide operation determination process such as the switching of the accessory switch from the on state to the off state is established (at S5). When determining that the end condition of the slide operation determination process is not established (NO at S5), the controller 2 returns the process to step S1, and repeats the process from step S1. On the other hand, when the controller 2 determines that the end condition of the slide operation determination process is satisfied (YES at S8), the controller 2 ends the slide operation determination process.

The controller 2 performs the following control by performing the above-described process.

As shown in FIGS. 4 and 5, when the driver performs the slide operation for sliding the left hand along the steering wheel 9 in a clockwise direction or a counter-clockwise direction with holding the steering wheel 9 with the right hand without steering after the state shown in FIG. 3, the steering angle does not become equal to or greater than the predetermined angle. At this time, the controller 2 determines the slide angle, outputs a control signal corresponding to the determined slide angle to the audio device 5, and adjusts the set sound volume of the audio device 5. That is, when the steering angle at the time the driver performs the slide operation is less than the predetermined angle, the controller 2 determines that the driver performs the slide operation for the purpose of adjusting the set sound volume of the audio device 5 instead of the steering of the own vehicle, and adjusts the set sound volume of the audio device 5 according to the driver's intention.

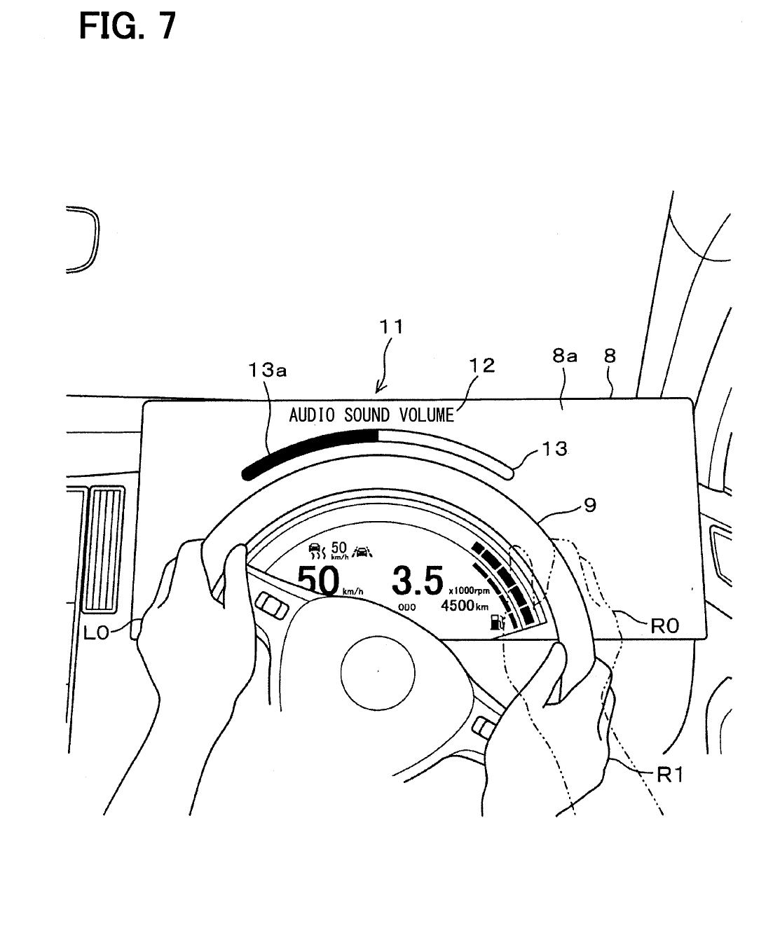

On the other hand, for example, when the driver turns the vehicle right at the intersection, as shown in FIGS. 7 to 9, the driver steers in the clockwise direction with holding the steering wheel 9 with the right hand after the state shown in FIG. 3 (that is, the driver moves the right hand from the position of “R0” to the position of “R1” while keeping a grip on the steering wheel 9 with the right hand). At that moment, when the driver slides the left hand along the steering wheel 9, this operation is equivalent to the sliding operation to slide the left hand along the steering wheel 9 in the counter-clockwise direction.

At this time, as shown in FIG. 7, when the driver does not change the position of the left hand, the controller 2 determines that the deviation between the slide angle and the steering angle is relatively small, and the difference between the slide angle and the steering angle is smaller than the reference angle. Thus, the controller 2 does not output the control signal to the audio device 5 so that the controller 2 does not adjust the setting sound volume of the audio device 5. That is, when the steering angle is equal to or larger than the predetermined angle, and the difference between the slide angle and the steering angle is less than the reference angle, the controller 2 determines that the slide operation is not the adjustment of the setting sound volume of the audio device 5, but the slide operation is the slide operation for the purpose of the steering of the steering wheel 9. Thus, the controller 2 does not adjust the setting sound volume of the audio device 5, and avoids a situation such that the setting sound volume of the audio device 5 is adjusted against the driver's intention.

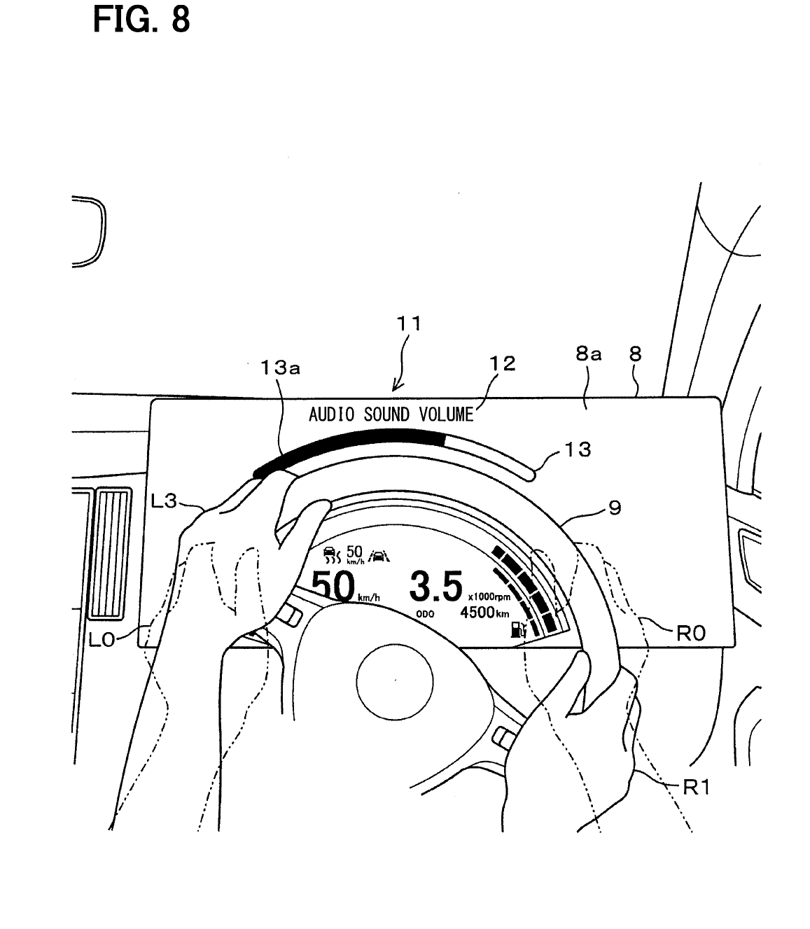

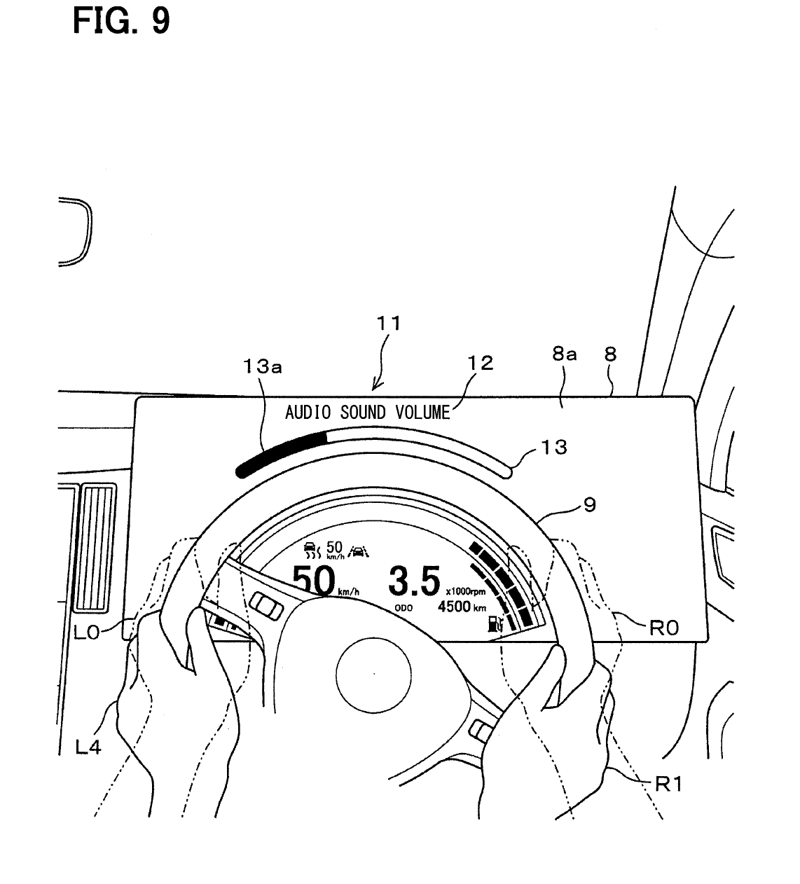

On the other hand, as shown in FIGS. 8 and 9, when the driver changes the position of the left hand, the controller 2 determines that the deviation between the slide angle and the steering angle is relatively large, and the difference between the slide angle and the steering angle is equal to or larger than the reference angle. Thus, the controller 2 outputs a control signal corresponding to the difference to the audio device 5, and adjusts the set sound volume of the audio device 5. That is, when the steering angle is equal to or greater than the predetermined angle, and the difference between the slide angle and the steering angle is equal to or greater than the reference angle, the controller 2 determines that the slide operation is the slide operation for the purpose of the adjustment of the setting sound volume of the audio device 5, and adjusts the set sound volume of the audio device 5 according to the driver's intention. That is, as shown in FIG. 8, when the driver performs a sliding operation to slide the left hand in the clockwise direction (that is, the driver slides the left hand from the position of “L0” to the position of “L3”), and the sliding angle is smaller than the steering angle and the difference between the slide angle and the steering angle is equal to or larger than the reference angle, the controller 2 outputs a control signal for designating an increase in the set sound volume to the audio device 5, and adjusts the setting sound volume of the audio device 5 to be larger. On the other hand, as shown in FIG. 9, when the driver performs a sliding operation of sliding the left hand in the counter-clockwise direction (that is, the driver slides the left hand from the position of “L0” to the position of “L4”), and the sliding angle is larger than the steering angle and the difference between the slide angle and the steering angle is equal to or greater than the reference angle, the controller 2 outputs a control signal for designating a decrease in the set sound volume to the audio device 5, and adjusts the set sound volume of the audio device 5 to be smaller.

As described above, the configuration described in the present embodiment can provide advantages below.

The vehicle operation system 1 selects whether the set sound volume of the audio device 5 is adjusted using the determination result of whether the driver has performed the slide operation and the determination result of the steering angle. When the steering angle at the time the driver performs the sliding operation is less than the predetermined angle, it is determined that the sliding operation is a sliding operation for the purpose of the adjustment of the setting sound volume of the audio device 5, not for the purpose of the steering of the own vehicle, and the set sound volume of the device 5 is adjusted. On the other hand, when the steering angle at the time the driver performs the slide operation is equal to or larger than the predetermined angle, it is determined that the slide operation is a slide operation aimed at the steering of the own vehicle, not the adjustment of the set sound volume of the audio device 5, and the setting sound volume of the audio device 5 is not adjusted. It is determined whether the slide operation performed by the driver is a slide operation for the purpose of adjusting the set sound volume of the audio device 5 or a slide operation for the purpose of steering the own vehicle, so that it is selected whether the set sound volume of the audio device 5 is adjusted. Thus, the set sound volume of the audio device 5 can be adjusted according to the driver's intention when the driver performs the sliding operation, so that a situation such that the setting sound volume of the audio device 5 is adjusted against the driver's intention is avoidable.

When it is determined that the steering angle is equal to or greater than the predetermined angle in the vehicle operation system 1, it is selected whether the setting sound volume of the audio device 5 is adjusted, using the determination result of the steering angle and the determination result of the slide angle. When the difference between the slide angle and the steering angle is less than the reference angle, it is determined that the sliding operation is a sliding operation aimed only for the steering of the own vehicle, and the setting sound volume of the audio device 5 is not adjusted. On the other hand, when the difference between the slide angle and the steering angle is equal to or greater than the reference angle, it is determined that the slide operation is a slide operation for the purpose of both the steering of the own vehicle and the adjustment of the set sound volume of the audio device 5, and the set sound volume of the audio device 5 is adjusted. Thus, it is possible for the driver to adjust the set sound volume of the audio device 5 while the driver steers the vehicle.

Although the present disclosure has been described in accordance with the embodiments, it is understood that the present disclosure is not limited to the embodiments and structures. The present disclosure may cover various modification examples and equivalent arrangements. Furthermore, various combinations and formations, and other combinations and formations including one, more than one or less than one element may be included in the scope and the spirit of the present disclosure.

A configuration in which the driver adjusts the set sound volume of the audio device 5 by performing the slide operation with the left hand is described. Alternatively, the driver may adjust the set sound volume of the audio device 5 by performing the slide operation with the right hand. Alternatively, it is also possible to provide a configuration in which the driver may select which one of the hands is used to perform the slide operation to adjust the set sound volume of the audio device 5.

A case where the driver adjusts the set sound volume of the audio device 5 by performing the slide operation is exemplified. Alternatively, embodiments may be applied to a case where the driver adjusts the set temperature of the air conditioner device 6 or the set air volume by performing the slide operation, or a case where the driver enlarges or reduces the map screen of the map display 7 by performing the slide operation.

A case where the driver turns the own vehicle right at the intersection is exemplified. Alternatively, embodiments may be applied to a case where the driver turns the own vehicle left at the intersection or curves the own vehicle.

S6 to S8 in FIG. 6 may be omitted. That is, as a situation in which the driver adjusts the set sound volume of the audio device 5 by the slide operation, it is considered that the own vehicle is going straight ahead. Thus, a possibility of a case where the driver adjusts the set sound volume of the audio device 5 by the slide operation while the driver is turning the vehicle to the right or left, or curving the vehicle may be considered to be low. For this reason, when determining that the steering angle is not less than the predetermined angle (NO at S2), the controller 2 does not compare the difference between the slide angle and the steering angle with the reference angle, does not output a control signal to the audio device 5, and does not output a display command signal to the meter display 8, but may determine whether the end condition of the slide operation determination process is satisfied. Further, even when comparing the difference between the slide angle and the steering angle with the reference angle, the controller 2 may set the reference angle to be an extremely large value. Further, the driver may set whether to allow or prohibit the adjustment of the set sound volume of the audio device 5 while steering the vehicle.

The display information 11 is displayed on the meter display 8. Alternatively, the display information 11 may be displayed on the head-up display.

The timing at which the display of the display information 11 is started or the timing at which the display of the display information 11 is ended may be set in any way. For example, when adjusting the set sound volume of the audio device 5, the display of the display information 11 may be started during the adjustment, or the display of the display information 11 may be started after the adjustment is completed. Alternatively, for example, the display of the display information 11 may be ended after a predetermined time (for example, several seconds) has elapsed from the start of the display of the display information 11.

An audio device, an air conditioner device, or a map display 7 is exemplified as a control target device. Alternatively, for example, an in-vehicle telephone fixedly installed in a vehicle, a simplified mobile phone that a driver can bring in a vehicle compartment, a multi-function type mobile phone such as a smartphone may be adopted. In case of a cellular phone that can be brought into the passenger compartment for the driver, the cellular phone is connected to the controller 2 via Bluetooth (registered trademark), thereby inputting various signals from the controller 2, and performing various controls.

What is claimed is:

1. A vehicle operation system for controlling a control target device by performing a sliding operation in which a driver slides a hand along a steering wheel, the vehicle operation system comprising:
an operation determination unit for determining whether the driver performs the slide operation;
a steering angle determination unit for determining a steering angle when the driver performs the slide operation after the operation determination unit determines that the driver performs the slide operation; and
a device controller that determines whether to control the control target device using a determination result of the operation determination unit and a determination result of the steering angle determination unit.

2. The vehicle operation system according to claim 1, wherein:
when the device controller determines that the driver performs the slide operation, and the steering angle is less than a predetermined angle, the device controller controls the control target device; and
the device controller does not control the control target device when the device controller determines that the driver performs the slide operation, and the steering angle is equal to or greater than a predetermined angle.

3. The vehicle operation system according to claim 1, further comprising:
a slide angle determination unit for determining a slide angle indicating an operation amount when the driver performs the slide operation, wherein:
when determining that the steering angle is equal to or greater than a predetermined angle, the device controller determines whether the device controller controls the control target device, according to the determination result of the steering angle determination unit and the determination result of the slide angle determination unit.

4. The vehicle operation system according to claim 3, wherein:
when determining that a difference between the slide angle and the steering angle is equal to or greater than the reference angle, the device controller controls the control target device; and
when determining that the difference is less than the reference angle, the device controller does not control the control target device.

5. The vehicle operation system according to claim 1, wherein:
at least one of adjustment of a set sound volume of an audio device, adjustment of a set temperature or a set air volume of an air conditioner device, enlargement and reduction of a map screen of a map display is performed as a control of the control target device.

6. (canceled)

7. A computer-readable non-transitory storage medium comprising instructions being executed by a computer, the instructions including a computer-implemented method for controlling a controller in a vehicle operation system, which controls a control target device by performing a sliding operation in which a driver slides a hand along a steering wheel, the instructions including:
determining whether the driver performs the slide operation;
determining a steering angle when the driver performs the slide operation after determining that the driver performs the slide operation; and
determining whether to control the control target device, according to a determination result in the determining whether the driver performs the slide operation and a determination result in the determining of the steering angle.
